(19) United States
(12) Patent Application Publication
(10) Pub. No.: US 2007/0067210 A1
(43) Pub. Date: Mar. 22, 2007

(54) Systems and methods for creating and maintaining a market intelligence portal

(75) Inventors: Bonnie Rishell, Vienna, VA (US); Archie Anderson, New York, NY (US); Stephen Mallette, Purcellville, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Prolink Services LLC (a Virginia company), Vienna, VA (US)

(21) Appl. No.: 11/501,223

(22) Filed: Aug. 9, 2006

Related U.S. Application Data
(63) Continuation-in-part of application No. 10/394,165, filed on Mar. 24, 2003, now abandoned.
(60) Provisional application No. 60/417,158, filed on Oct. 10, 2002.

(51) Int. Cl. G06F 17/30

(52) U.S. Cl. 705/10

(57) ABSTRACT

Systems and methods for creating and maintaining a market intelligence portal. Using automated data processing techniques, a market intelligence campaign is defined and executed to determine the most productive approach for marketing new products in a particular market segment. A key component of the systems and methods is identifying key opinion leaders who are deemed by their peers to be influential in a particular therapy space through surveying techniques. In addition to opinion leader information obtained through surveying, external data sources are used to create a detailed profile for each opinion leader identified through surveying. Social network mapping and other analysis is performed on the profiles. The survey results, profiles and social network diagrams are stored electronically on a network portal. An interactive dashboard interface to the portal is created so that the data can be accessed and visualized remotely, preferably using a web browser interface. One or more data streams are used to self-update the data as new data relevant to the campaign and/or the opinion leader profiles is available. The various systems and methods may have particular utility to pharmaceutical companies trying to gain market acceptance of new drug therapies.

### CROSS REFERENCE TO RELATED APPLICATION(S)

This application is a continuation-part-of application Ser. No. 10/394,165 entitled “Method and System for Identifying Key Opinion Leaders,” which filed on which was filed on Mar. 24, 2003 and which claimed priority to Provisional Application No. 60/417,158 filed on Oct. 10, 2002. Both of these applications are herein incorporated by reference in their entirety into the disclosure of this application.

### FIELD OF THE INVENTION

The present invention relates to automated information gathering, analysis and visualization techniques and more particularly to systems and methods for creating and maintaining a market intelligence portal (MIP) for providing market intelligence information relevant to promotion of products such as pharmaceuticals and other treatments in a particular market segment, such as a particular therapy space.

### BACKGROUND OF THE INVENTION

In addition to the tremendous expense involved in developing new pharmaceuticals, treatments and other medical devices, drug, life science and medical technology companies must spend significant amounts of money to successfully commercialize new treatments and/or products and to gain market acceptance by the practitioners who use, prescribe and/or follow them. Because of the huge amount of potential revenue and intense competition for market share, time and effectiveness of marketing efforts are of the essence. Rather than “shotgunning” their marketing efforts to all practitioners in a particular therapy space, medical companies usually prefer to develop relationships with certain key practitioners whose opinions are highly regarded by others within their the space. These persons, sometimes called “key opinion leaders,” “KOLs,” or simply “opinion leaders,” are often invited to give speeches, submit articles to medical journals, conduct clinical trials or otherwise provide their knowledge and experience with others within their specialty. As such, their opinions regarding a certain drug or other treatment often have a considerable impact on its adoption and ultimately its commercial success (i.e., sales).

Due to the potential cost savings resulting from focused marketing efforts on opinion leaders, pharmaceutical manufacturers spend considerable resources trying to identify the opinion leaders in a given medical field. One common method includes utilizing research specialists to analyze journal articles and press articles, attend conferences and industry meetings, or otherwise perform research to identify those practitioners who may be opinion leaders. This way can be time consuming, expensive and subject to underexposure—that is, it can fail to discover some opinion leaders.

Another method for identifying key opinion leaders is to use surveying techniques, such as that disclosed in parent application Ser. No. 10/394,165. The automated system for identifying key opinion leaders described in that application solves several of the problems associated with manual surveying techniques such as reduction in manual operations, increased speed and efficiency, automatic results verification, and result stats. While this system represents a significant improvement over existing surveying techniques, it still suffers from some short comings. For example, the system is still reliant on survey information as its only data source. Also, additional surveying must be performed to provide new data.

Thus, there is a need for a market intelligence portal to identify key opinion leaders for targeting marketing campaigns to promoting new treatments in a particular therapy space that provides, dynamic, updated, multi-source information.

### SUMMARY OF THE INVENTION

In view of the above noted shortcomings of existing systems and methods, various embodiments of the invention provide systems and methods for creating and maintaining a market intelligence portal for providing market intelligence data relevant to promoting a new treatment in a particular therapy space. The systems and methods according to the various embodiments of the invention supplement key opinion leader identification techniques based on surveying, with manual follow up, subject matter expert transcription, multiple external self-updating data sources, automated detailed practitioner profile creation, social network mapping, dashboard interface, watch list creation and automated update alerts.

Accordingly, at least one exemplary embodiment of the invention provides a market intelligence portal (MIP) for providing market intelligence data relevant to a medical company's marketing campaign. The market intelligence portal according to this embodiment comprises an Internet-based information portal comprising a survey module, a campaign dashboard interface module, a data stream module, an influence mapping module, and an alert module.

Another exemplary embodiment of the invention provides a market intelligence portal (MIP) system for providing a medical company with market intelligence data relevant to the medical company's marketing campaign. The market intelligence portal according to this embodiment comprises a network-based computer system comprising a surveying module, adapted to generate an opinion leader survey of practitioners working in a particular clinical therapy space relevant to the marketing campaign to identify practitioners regarded by the participants as key opinion leaders in the therapy space and to store the survey results, a practitioner profile module adapted to create a practitioner profile for each opinion leader in the survey including one or more information fields selected from the group consisting of scientific contributions, speaking experience, regulatory experience, institutional affiliation, educational background, awards, and clinical trial participation, a data stream module adapted to receive automatic data updates relevant to practitioner profiles, an influence mapping module adapted to create at least one social network diagram for each identified practitioner, the social network diagram illustrating a connection between practitioners based on a commonality in one or more of the information fields, a campaign dashboard module for accessing the practitioners profiles, social network diagrams and data updates over a computer network, and an alert module adapted to permit viewers to establish an automatic alert when a practitioner profile is updated with data update information.

In a further embodiment of the invention, a method of obtaining market intelligence data related to marketing of a new pharmaceutical in a specific therapy space is provided. The method according to this embodiment comprises identifying a number of practitioners working in the particular therapy space, generating an opinion leader survey for the practitioners that requests the respondent to name at least one practitioner in the therapy space that the respondent regards as an opinion leader, providing the opinion leader survey to the identified practitioners, including a financial incentive to participate in the survey, receiving the survey responses and transcribing the response data into an electronic database, for each identified opinion leader, obtaining additional information comprising one or more fields of information selected from the group consisting of scientific contributions, speaking experience, regulatory experience, institutional affiliation, educational background, awards, and clinical trial participation, creating a practitioner profile for each named practitioner using the survey responses and the additional information, creating a social network diagram for each named practitioner relative to other named practitioners based on commonality between one or more fields of the additional information, creating a campaign dashboard for a requestor of the market intelligence data to interact with the practitioner profiles and social network diagrams, and automatically updating the practitioner profile with information from one or more self-updating external data sources.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a schematic diagram illustrating system components of an exemplary market intelligence portal system for providing a medical company with market intelligence data relevant to the medical company's marketing campaign according to at least one embodiment of the invention;

FIG. 2 is a functional block diagram illustrating exemplary internal functional components of a market intelligence portal system according to at least one embodiment of the invention;

FIG. 3 is flow chart detailing the steps of a method for obtaining market intelligence data relevant to marketing of a treatment in a specific therapy space with a market intelligence portal system according to at least one embodiment of the invention;

FIG. 4 is a exemplary browser interface window of a market intelligence campaign dashboard interface according to at least one embodiment of the invention;

FIG. 5 is an exemplary browser window of a practitioner profile page of a market intelligence campaign dashboard interface according to at least one embodiment of the invention; and

FIG. 6 is an exemplary browser window of a watch list page of a market intelligence campaign dashboard interface according to at least one embodiment of the invention.

### DETAILED DESCRIPTION

The following description is intended to convey a thorough understanding of the embodiments described by providing a number of specific embodiments and details involving a market intelligence portal system for providing a market intelligence campaign relevant to promoting a new treatment in a particular therapy space. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

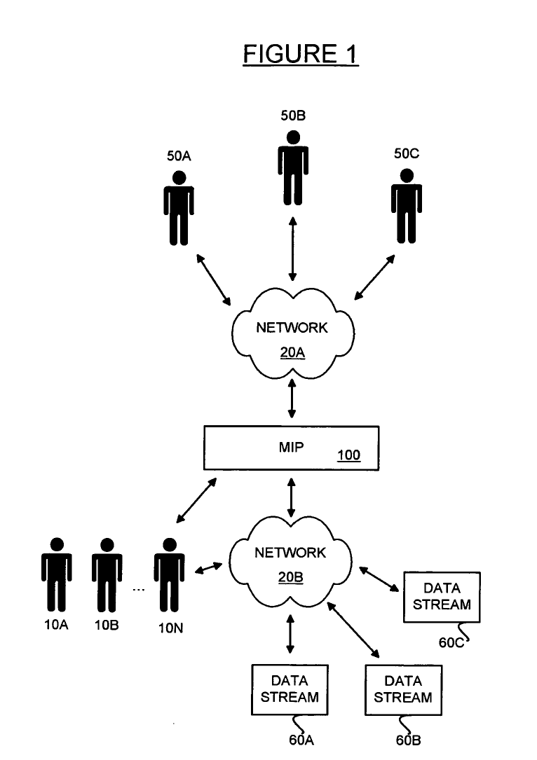

FIGS. 1-6 illustrate exemplary systems and methods of implementing an market intelligence portal to facilitate gathering, formatting and presenting of market intelligence data relevant to a medical company's marketing campaign for a new treatment protocol in a particular therapy space. The system preferably includes one or more server computers which are adapted to support a website through which clients view and interactive with market intelligence data. The system is based on practitioner surveying, human data validation and transcription, as well as on automated search techniques using data streams, commercial data services and other data sources. The system is also adapted to generate an interactive dashboard interface through which clients may visualize and analyze their continuously evolving market intelligence data.

For ease of illustration, an exemplary architecture for implementing and maintaining a market intelligence portal having market intelligence data relating to promotion of a new treatment in a particular therapy space including identification information of opinion leaders in that therapy space is discussed in detail below. However, the exemplary system(s) and method(s) discussed herein can be adapted for other purposes without departing from the spirit or the scope of the present invention. Indeed, the present invention could be implemented to gather market intelligence data in the fields of politics, law, engineering, business, fashion, academics, as well as any other field wherein a subset of individuals or entities have an identifiable and appreciable impact on their respective field.

Terms and Definitions

As used herein the phrases “market intelligence data” will be interpreted broadly to mean data indicating persons, institutions, organizations and other entities, and even publications that are deemed through either subjective or objective evidence to be relevant to a particular field, such as a particular therapy space in the context of pharmaceuticals, medical devices, etc. This data may include information corresponding to key opinion leaders including their names and affiliations, geographic location, relevant experience such as clinical experience, teaching experience, public speaking experience, regulatory experience, authorship, clinical trial participation, prescribing history, etc. In addition to data on individuals, this may also include aggregated data in forms including tables, charts, interactive graphics, etc. A “market intelligence campaign” will refer to the process of obtaining market intelligence data using the various systems and methods corresponding to the embodiments of the invention.

The term “opinion leader survey,” as used herein, refers to a survey having questions or input fields that are used by a survey participant to name one or more persons that the respondent regards as an opinion in his or her particular therapy space (i.e., medical field). The opinion leader survey also may include questions or input fields used to obtain information about the identified opinion leaders and/or to obtain additional information about the survey participant.

The term “medical practitioner,” as used herein, refers to an individual who is involved in the prescription, distribution, purchase, or use of drugs or other pharmaceuticals. Examples of medical practitioners can include, but are not limited to, physicians, psychiatrists, psychologists, pharmacists, nurses, physician assistants, hospital administrators, medical experts, and the like. The term “pharmaceutical representative,” as used herein, refers to an individual who is involved in the marketing and/or sales of drugs or other pharmaceuticals produced by a pharmaceutical manufacturer

The phrase “campaign dashboard interface” will refer to a customizable web browser-based software interface to the market intelligence portal (MIP) system that is used by clients to interact with the market intelligence data that has been gathered for them. The campaign dashboard will typically include some client customization and a set of standardized functionality such as opinion leader reports and practitioner profiles, as well as customizable, interactive functions such as custom reports and analysis, watch lists and alerts.

The term “data stream” will refer to any connection to an external data source such as a self updating connection to the Internet, a connection to one or more commercial data providers, a connection to remote databases such as drug prescription databases, clinical trial databases, a connection to a newswire service, or other external data source that pushes data into the market intelligence periodically, and/or on demand.

The term “therapy space” will be used herein to refer to a particular area of focus of the market intelligence campaign. In the context of pharmaceuticals and other treatment protocols, this has specific meaning and refers to a particular medical discipline or field of study.

The term “medical company” as used in the disclosure and claims will be interpreted broadly to refer to pharmaceutical companies, life science companies, medical device/instrument companies, etc. All of these types of companies are innovators who, in addition to developing new treatment protocols, must undertake the task of gaining marketplace acceptance of their products and thus, may all benefit from the various systems and methods according to the embodiments of the of the invention.

### EXEMPLARY EMBODIMENTS

Referring now to FIG. 1, a schematic diagram illustrating system components of an exemplary market intelligence portal system for providing a medical company with market intelligence data relevant to the company's marketing campaign according to at least one embodiment of the invention is depicted. The system comprises a market intelligence portal (MIP) 100 that is connected to a plurality of client computer systems 50A, 50B, 50C via a network 20A, such as public wide area network like the Internet. In a preferred embodiment, client computer systems interact with the MIP 100 using an Internet-compliant web browser client such as any of the ubiquitous MICROSOFT INTERNET EXPLORER, NETSCAPE NAVIGATOR or MOZILLA FIREFOX web browser clients. In addition to passing web-based content, network 20A may also pass emails, facsimiles and other electronic communications and/or information transfers between the MIP 100 and the client computer systems 50A, 50B, and 50C.

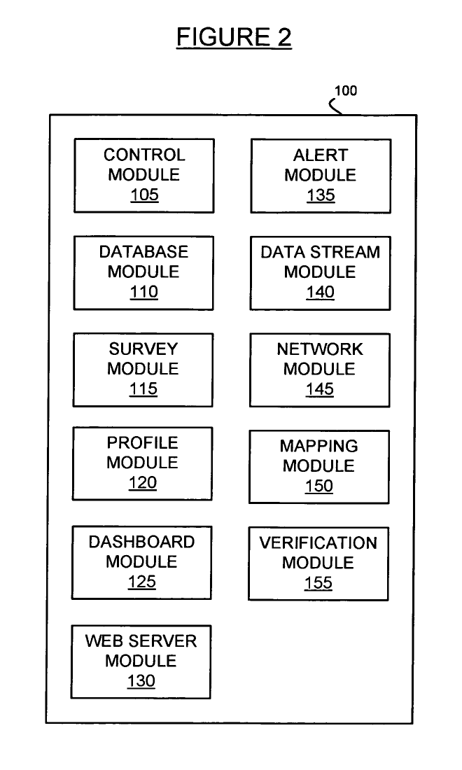

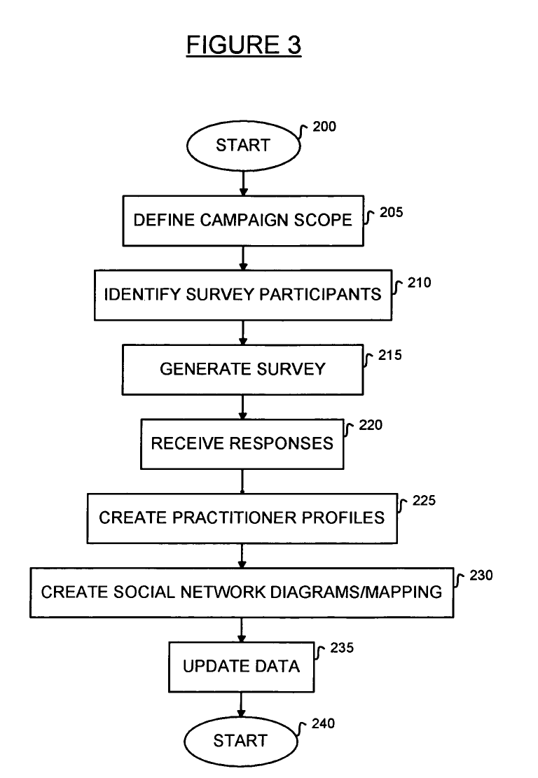

In addition to client computers systems 50A, 50B and 50C, the MIP 100 is also in communication with a plurality of practitioners 10A, 10B, . . . , 10N. As will be discussed in greater detail in the context of FIGS. 2 and 3, one function performed by the MIP 100 is to identify key opinion leaders through surveying techniques. In various embodiments, surveying may comprise generating an opinion leader survey relevant to the particular therapy space associated with the campaign and storing results of the survey that have been transcribed through subject matter expert transcription. The surveys may comprise paper surveys or telephone surveys. In various other embodiments, surveying comprises soliciting responses to an Internet or email-based survey stored on a server computer system associated with the MIP 100, and via email messages sent over the network 20B. Refer to parent application Ser. No. 10/394,165 for a detailed discussion of automated opinion leader surveying techniques.

The MIP 100 is also connected to one or more data streams 60A, . . . , 60N which provide continuously or periodically updated market intelligence data to the MIP 100. In a preferred embodiment, the network 20B is the same network as the network 20A, such as, for example, the Internet. However, those of ordinary skill in the art will appreciated that networks 20A and 20B may be separate networks such as private networks, telephone networks, wireless networks, etc.

Referring now to FIG. 2, a functional block diagram illustrating exemplary internal functional components of a market intelligence portal system, such as the MIP 100 of FIG. 1, according to at least one embodiment of the invention is depicted. In the system 100 of FIG. 2, the architecture is that of a server computer system having a plurality of different modules. For ease of illustration, the system 100 is depicted as a single, unitary system. However, those of ordinary skill in the art will appreciate that one or more of the modules may be located in a separate structure and even at separate physical locations. The specific system topology is not critical to the various embodiments of the invention.

The system 100 of FIG. 2 is comprised of a plurality of individual modules including a control module 105, a database module 110, a surveying module 115, a profile module 120, a dashboard module 125, a web server module 130, an alert module 135 a data stream module 140, a network interface module 145, a mapping module 150, and a verification module 155. It should be appreciated that the various modules may comprise separate circuits, routines, applications and/or processors or may comprise sub-elements of a single circuit, routine, application and/or processor. One or more modules may comprise software, hardware, an application specific integrated circuit (ASIC), programmable memory structure, or other data structure. Also, fewer or more modules than those shown in the Figure may be utilized, and even different modules than those shown may be utilized without departing from the spirit or scope of the invention.

In various embodiments of the invention, the control module 105 may be one or more microprocessors of a server computer. The control module 105 may also be a symbolic representation of a program kernel of a control program/operating system of the MIP 100. In various embodiments, the control module 105 will invoke each of the other modules as necessary to perform the various functions provided by the MIP 100. In various other embodiments, one or more of the modules of the MIP 100 may operate autonomously with respect to the control module 105.

The database module 110 may comprise a relational database or relational database management system (RDMS). Any suitable commercial-off-the-shelf (COTS) DBMS may be utilized with the various embodiments of the invention. In various embodiments, all market intelligence data is stored in the database module 110. For example, in one embodiment, when a market intelligence campaign is initiated, if automated surveying is used, the survey module 115 will send out an electronic message to a predetermined list of medical practitioners who are deemed to be relevant to the particular therapy space targeted by the campaign. In various embodiments, the survey module 115 will query a practitioner list in the database module 110 to determine the list. In various other embodiments, a system administrator will supply the list to the surveying module. In this embodiment, the electronic message will contain a hyperlink that directs the recipient to a webpage containing one or more survey response forms maintained by the web server module 130. As noted in the parent application Ser. No. 10/394,165, the message may contain a promise of an honorarium or other incentive designed to motivate the recipient to complete the survey. In various embodiments, the electronic survey will ask the respondent to name one or more persons whom they regards as an influential—that is, as an opinion leader—in their particular field. For a complete discussion of electronic surveying, refer to the Ser. No. 10/394,165 application which has been incorporated by reference into this application. In various embodiments, when a respondent has complete the survey and submitted it, such as by clicking a “submit” button, the surveying module will perform a verification process on the data to insure that it is complete, that all necessary fields have been supplied and that no other detectable errors are present. This step may comprise comparing one or more of the supplied fields against data stored in the database module 110, such as to detect duplicate submitter entries. In various embodiments, once the data has been verified, the surveying module will release the offered honorarium. In various embodiments, this may comprise updating a table of recipients approved to receive honorariums. In various other embodiments, this may comprise effecting an automated payment, order, transfer, etc., of the offered honorarium.

In embodiments, not reliant upon automated surveying, the surveying module 115 may only be used to create the opinion leader survey and/or to identify survey participants. In such embodiments, surveys will be sent out to the selected participants in the form of a paper survey. A honorarium, such as a check may be sent with the surveys to entice the recipient to participate. Alternatively, the selected participants may be sent a the honorarium along with a request for the participant to call a telephone number to conduct a phone-based survey. Alternatively still, the participant may be called directly. In these embodiments, based on manual surveying, a copy of the survey response, or in the case of telephone surveys, a recording of the interview may be stored in the database module 110 and made available through the dashboard module. In various embodiments, a subject matter expert (SME) will review the survey responses, either paper or recorded and transcribe them into a data record. In various embodiments, the SME may search for additional data on the identified opinion leader or, direct the server 100 to seek out additional information, such as via the data stream module 140.

In various embodiments, after a sufficient number of survey results have been received or entered into the database module 110, the profile module 120 will extract and rank the survey results, developing a ranked list of practitioners deemed by their peers to be influential opinion leaders in their field. In various embodiments, the profile module 120 will generate a detailed profile for each listed practitioner. The detailed profile may include fields such as scientific contributions, speaking experience, regulatory experience, institutional affiliation, educational background, awards, and clinical trial participation. In various embodiments, all this information may not be supplied in the survey responses. Therefore, the profile module 120, in various embodiments, will use the information that is supplied, generally at least a practitioner name, to gather additional information. In various embodiments, this will be performed by connecting to a network such as the Internet or other network and/or data service/portal and performing searches for additional information, such as via the data stream module 140 and/or the network module 145. In various embodiments, this may comprise searching databases of technical journals, conference proceedings, drug prescription records, commercial databases, etc. In various embodiments, some or all of this is performed using automated data gathering techniques, such as web crawlers, predefined searches, etc. In various embodiments, at least some of this additional data gathering is performed under the direction of one or more subject matter experts (SMEs) having particular knowledge in the specific therapy space of the market intelligence campaign. In various embodiments, the profile module 120 stores all the gathered information associated with each practitioner as indexed profiles in the database module 110. In various embodiments, the profile is structured as a series of field/value pairs and the data stream module 140 is employed to automatically updated information relevant to the various values. For example, if the value is the practitioner's name, the data stream module, which comprises a connection to one or more external, self-updating data sources, will periodically search for new information including that practitioner's name. Also, if the data field is a specific clinical trial, the data stream module 140 will update information related to that clinical trial when it is detected, such as by periodically searching an external clinical trials database. In this manner, the campaign data in the database module 110 is continuously evolving and remains current. In yet another example, if a new article is discovered naming one or more of the listed practitioners, the data stream module 140 will update that practitioner's profile in the database module 110 to include at least a reference to the new article. Thus, rather than providing medical companies with a static market snapshot, which becomes dated as soon as it is taken, various embodiments of the invention provide a value-added portal of continuously updated market intelligence data relevant to their selected therapy space.

Though it should be appreciated that the profile module 120, may continuously update practitioner profiles as new information is supplied by the data stream module 140, in various embodiments, after the profiles have been created and expanded at least once by the profile module 120, the mapping module 150 will perform a mapping between practitioners in the database module 110. In various embodiments this will comprise creating one or more social network diagrams or association diagrams between practitioners based on a commonality between one or more of the fields. For example, if multiple practitioners, co-authored a paper, participated in the same clinical trials, worked or work at the same facility, graduated from the same medical school, etc., they will have commonality between one or more of the profile fields. The social network diagram will represent practitioners as nodes and commonalities as connections. In various embodiments, the mapping module 150 will only map practitioners in the same therapy space. However, in various embodiments, the mapping module 150 will also map practitioners in other therapy spaces that are stored in the database module 110. In various embodiments, the social network diagram will comprise a hub and spoke terminating with one degree of separation, that is, at nodes in direct contact with the practitioner. In various other embodiments, the social network diagram will extend through the first degree of separation and show connections of those practitioners contacting the particular practitioner. In various embodiments, the mapping module 150 will also create geographical diagrams such as maps and other geo-analytic visualizations. See the parent application Ser. No. 10/394,165 for a detailed discussion and illustrations of social network and geo-analytical diagrams.

After the profile module 130 has completed the detailed practitioner profiles and the mapping module 150 has created maps and diagrams, all the market intelligence data is stored in the database module 110. Medical company personnel or other MIP clients may then interact with the market intelligence data to view the campaign results, create visualizations, and perform their own analysis. In various embodiments, these persons will access the MIP 100 through a web browser interface. In various embodiments, the web server module 130 will create and maintain a web page associated with the client's market intelligence campaign. In various embodiments, viewers of the market intelligence data will log on through a typical browser-based log on screen. In various embodiments, the verification module 155 will verify user log on data against an authorized user list in the database module 110. In various embodiments, the log on credentials will dictate the content of data viewable by the person attempting to gain access. For example, if the person's log on credentials are associated with Company X, after verifying that the person is an authorized user for Company X, the verification module 155 will automatically invoke the dashboard module 125 which, will provide a dashboard view of Company X's market intelligence data.

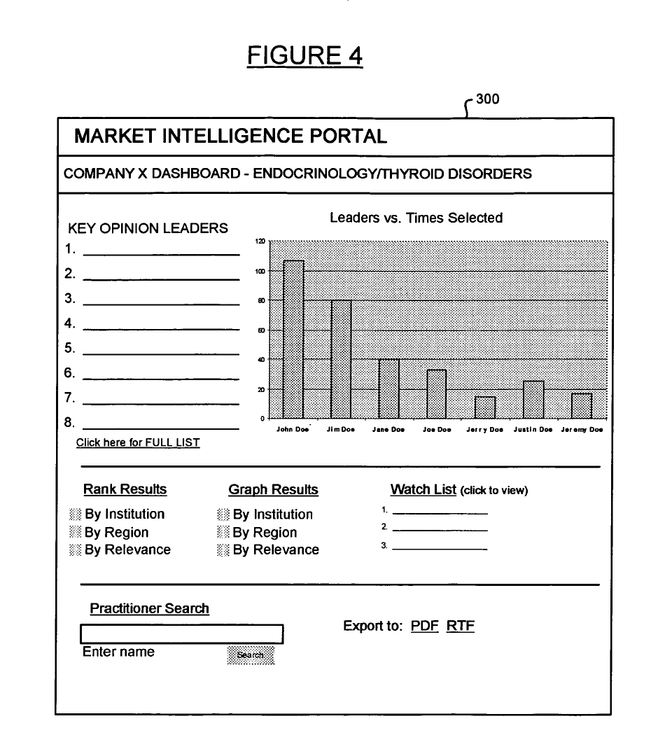

The dashboard module 125 will present the user with a dashboard type view of the market intelligence data. As will be discussed in greater detail in the context of FIG. 4, this may comprise a central page of both textual and graphical information through which viewers access and interact with the market intelligence campaign information. In addition to viewing opinion leader lists, social network diagrams, and detailed practitioner profiles, the dashboard module 125 will also provide access to the alert module 135. In various embodiments, the alert module will permit a user to define a watch list and/or to set up automatic alerts so that they are notified when new information is received or when an update to one or more designated fields is received. In various embodiments, the alert module will allow the user to specify the preferred method of alert contact, such as email address, text message address, phone number, fax number, etc.

In various embodiment, the communication module is a network interface card or other network interface hardware and/or software for facilitating an electrical connection between the MIP 100 and users, external data sources, the Internet and/or other communication networks.

Referring now to FIG. 3, this Figure depicts a flow chart detailing the steps of a method for obtaining market intelligence data relevant to marketing of a treatment in a specific therapy space with a market intelligence portal system according to at least one embodiment of the invention. The method begins in step 200 and proceeds to step 205 where, a scope of the market intelligence campaign is defined. In various embodiments, this may comprise defining a particular therapy space, such as in the context of pharmaceutical companies. Then, in step 210, a list of survey participants is defined. As discussed herein, in various embodiments, the market intelligence portal will select survey participants automatically from a database of practitioners based on the campaign scope specified in step 205. In various other embodiments, this may comprise receiving a list of survey participants.

Next, in step 215, after the list of participants has been selected, the survey will be created and sent out to the persons on the list. In embodiments reliant upon electronic surveying techniques, the survey or a request to participate in the survey will be sent out electronically by the server. In such embodiments, the request is sent with a hyperlink to the survey in an electronic mail message. Clicking on the hyperlink will preferably direct the respondent to a website containing the survey form. Alternatively, the survey may be embedded in the body of the email message and it may be submitted by return email. As discussed herein, as well as in the parent application, in various embodiments, the survey will request that the participant name one or more persons that the participant regards as influential, that is, as a key opinion leader, in the participant's particular field.

Using manually surveying techniques, step 215 will comprise sending out a paper-based survey to participants or alternatively, calling survey participants directly to participate in a recorded telephone survey.

In step 220, the survey responses are received at the market intelligence portal. If the surveys are done using automated techniques, the data fields supplied in the surveys are automatically written to a database of market intelligence data. Otherwise, if the surveys are done using manual techniques, the surveys must be transcribed in addition to being scanned in and stored in raw form. In various embodiments, a subject matter expert (SME) will read each written survey and transcribe the information into the database as a verified data record. This may require the SME to search for and obtain additional information on the identified opinion leaders. If the survey is a telephone survey, the SME must transcribe from the audio recording. In various embodiments, the server may automatically search for additional information on identified key opinion leaders, regardless of whether manual or automated surveying techniques are employed.

Next, in step 225, detailed practitioner profiles are created for the practitioners identified in the survey responses. As discussed herein, in various embodiments, this may comprise obtaining further information to expand upon the information provided in the survey responses. For example, for a particular named practitioner, the survey response may not indicate any publications or conferences sponsored by the named practitioners. Automated data gathering techniques may be used to search public and private data networks for this type of information for the particular named practitioner. This information is then included in that practitioner's detailed profile. As previously noted, subject matter experts (SMEs) may assist in the step of creating the detailed practitioner profile.

After the detailed profile has been created in step 225, social network diagrams and other mapping is performed in step 230, based on the information contained in the detailed profile. That is, in one example, commonalities between various profile fields of the named opinion leading practitioners, are used to map connections between them. Also, geographical maps may be created to provide interactive user visualizations illustrating opinion leaders as dots or other graphics overlaying a map based on their location.

Next, in step 235, a campaign dashboard is created for the particular market intelligence campaign. In various embodiments, the campaign dashboard will be created using automated techniques based on a dashboard template. That is, the dashboard will include a set of features that are common to dashboards created for other companies using the MIP, but with customized labeling and customizable interfaces. In various embodiments, the campaign dashboard will be associated with a unique web page address for the particular medical company for whom it was created. Once created, company personnel may interact with the MIP via the campaign dashboard to visualize the campaign results and to interact with and analyze the data.

The method continues in step 240, where the market intelligence data is updated. As noted above, the data in the MIP is continuously evolving based on one or more data streams from external data sources that are programmed to push newly acquired data relevant to the company's market intelligence campaign. In this way, the company may have more than a mere snapshot of the market. In a preferred embodiment, MIP access is designed as a subscription-based service.

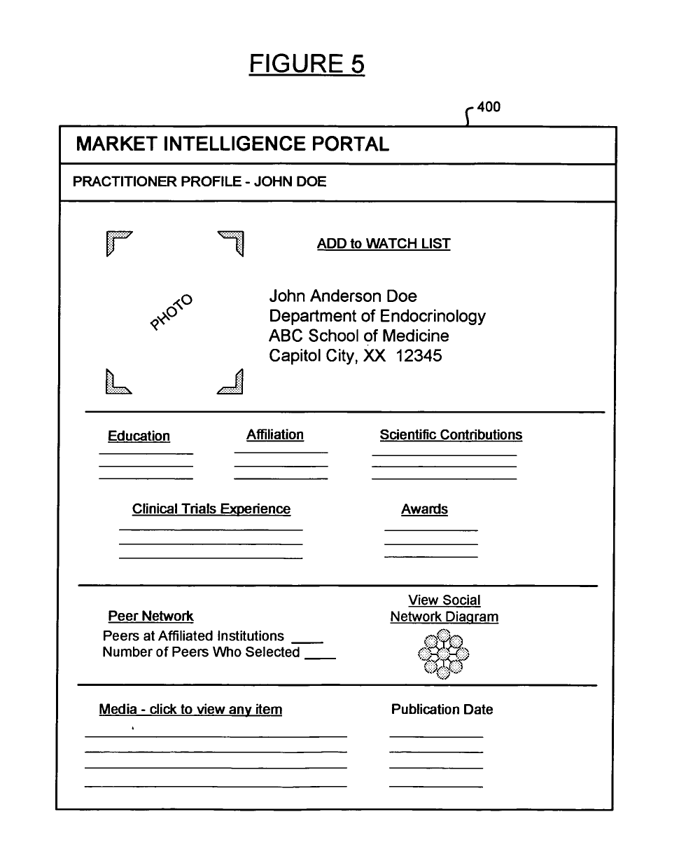

Referring now to FIG. 4, this Figure illustrates an exemplary browser interface window of a market intelligence campaign dashboard interface according to at least one embodiment of the invention. The dashboard interface 300 comprises a customizable graphical interface for interacting with the market intelligence data gathered for a company's market intelligence campaign, in this example a fictitious company labeled “Company X.” In the example of FIGS. 4 and 5, the market intelligence campaign has been focused on the particular therapy space of endocrinology, and in particular, thyroid disorders. The dashboard interface 300 includes a list of opinion leader practitioners obtained through automated surveying techniques, telephone interviews and/or other techniques. In various embodiments, the dashboard interface 300 will present the key opinion leaders as either a list, a graph or combinations of both and will also include a count of the number of times the particular practitioners was selected for relevance ranking purposes.

In various embodiments, the viewer will be able to customize the dashboard view to show or hide various components such as, graphs, lists, institutional affiliations, etc. For example, in various embodiments, the user may be able to show or hide a watch list module so that the module appears or disappears on the interface 300 when the user logs on. Also, the user may be able to select the type of results graph that will appear by default. In various embodiments, the dashboard interface 300 will include a graph control that permits the user to view the opinion leader results in a variety of different visualizations, including, for example, graphics illustrating the number of times selected (i.e., ranked), institutional affiliations (i.e., hospital, university, etc.), and/or geographic metrics (i.e., state, region, etc.).

FIG. 5 is an exemplary browser window of a practitioner profile page accessed via the market intelligence campaign dashboard interface according to at least one embodiment of the invention. In various embodiments, selecting a practitioner from the results lists or other graphic visualization, will automatically invoke a web page 400 containing the detailed practitioner profile for the selected practitioner in either the current or a separate web page. In various embodiments, the detailed profile will include several categories of information specific each practitioner. For example, the exemplary profile page 400 includes biographical information (photo, contact information, address, education, scientific contributions, clinical trial experience, awards), affiliation information, peer network information and media information (publications). In various embodiments, the various categories of data will be presented in a hierarchical structure so that a user can drill down into greater detail by selecting any one item. In various embodiments, publications, press releases and other articles listed in the media category will be clickable so that selecting them will either open the particular item, or direct the user to a webpage or open a new browser window containing the selected item. In various embodiments, the peer network category will include information fields such as number of peers at affiliated institution(s) and the number of peers who selected the current practitioner as a key opinion leader in the therapy space. The peer network category will also include a link to view the social network diagram for that practitioner. As discussed above, in various embodiments, this will comprise a tree diagram with a nodes and links where nodes are other practitioners and branches represent commonality between one or more practitioner profile fields.

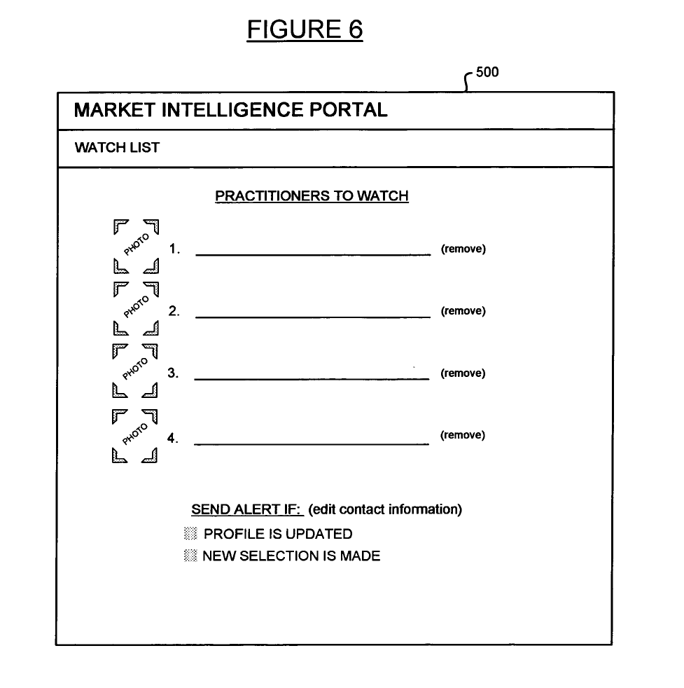

In various embodiments, the practitioner profile page 400 will also include an “Add to Watch List” link. This link will automatically add the particular practitioner to the viewer's watch list—a feature accessible through the campaign dashboard interface 300. In various embodiments, the watch list can serve at least two functions. Firstly, the watch list can serve as a favorites list for practitioners of particular interest to the viewer, such that when the viewer logs on to the MIP, the watch list, or a link to the watch list will be presented on the dashboard interface. The viewer can then access the profiles for the practitioner's on his/her watch list without having to key in their names. Secondly, the watch list can server as means to trigger alerts, as shown in FIG. 6.

FIG. 6 is an exemplary browser window of a watch list page of a market intelligence campaign dashboard interface according to at least one embodiment of the invention. As mentioned above, in various embodiments, the watch list 500 may appear in a condensed form on the dashboard interface 300. However, in various other embodiments, the dashboard interface may only contain a link to the watch list page 500. The watch list provides a mechanism for viewers to establish a “favorites” list of items that are of particular interest to them. In the example of FIG. 6, the items are practitioners. However, it should be appreciated that items may also comprise affiliations such as hospitals and/or universities, or virtually any other field from the detailed practitioner profile. By selecting the watch list, viewers can directly access the detailed profiles of their “favorite” practitioners. Also, in various embodiments, the watch list provides a mechanism for viewers to program one or more alerts relating to their watch list items. For example, as shown in FIG. 5, a viewer is able to have an alert generated in response to a profile being updated, or a new selection being made—that is, another survey respondent selecting the practitioners as a key opinion leader. It should be appreciated these particular alert triggers are exemplary only. In various embodiments, the viewer may select additional alert triggers or even program their own alert triggers. Furthermore, in various embodiments, the watch list page 500 will provide a link to edit the alert contact information so that the viewer can specify the preferred method of contact (i.e., email, facsimile, etc.) Alternatively or in combination, alerts may appear on the dashboard interface 300 when the user logs into to MIP. The watch list and alert features may be particularly useful in the MIP system according to the various embodiments of the invention, because of the self-updating feature of the MIP provided by the one or more data streams that continuously and/or periodically update the market intelligence data in the MIP. Without the alert feature, users may not discover data updates on their own.

The embodiments of the present inventions are not to be limited in scope by the specific embodiments described herein. For example, although many of the embodiments disclosed herein have been described in the context of a market intelligence portal and market intelligence campaigns related to promoting pharmaceuticals, other embodiments, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Many modifications to the embodiments described above can be made without departing from the spirit and scope of the invention. Accordingly, the claims set forth below should be construed in view of the full breath and spirit of the embodiments of the present inventions as disclosed herein. Also, while the foregoing description includes many details and specificities, it is to be understood that these have been included for purposes of explanation only, and are not to be interpreted as limitations of the present invention.

1. A market intelligence portal (MIP) for providing market intelligence data relevant to a medical company's marketing campaign comprising:
an Internet-based information portal comprising:
a survey module;
a campaign dashboard interface module;
a data stream module;
an influence mapping module; and
an alert module.

2. The market intelligence portal according to claim 1, wherein the survey module comprises a database of survey response information including responses to opinion leader surveys received from medical practitioners associated with a particular therapy space to identify medical practitioners who are regarded as key opinion leaders within that therapy space.

3. The market intelligence portal according to claim 2, wherein survey response information comprises transcribed opinion leader response surveys.

4. The market intelligence portal according to claim 2, wherein survey response information comprises audio files of telephone-based opinion leader surveys.

5. The market intelligence portal according to claim 2, wherein the survey module comprises a system for automated opinion leader surveying

6. The market intelligence portal according to claim 5, wherein the system for automated opinion leader surveying comprises:
a web server adapted to:
provide, to a plurality of survey participants, data for display as at least one web page, the at least one web page representing an opinion leader survey, the survey including at least one input field that is used by each survey participant to specify at least one medical practitioner whom the participant regards as an influential opinion leader in the particular therapy space; and
receive, via the at least one displayed web page, a survey response from each of a subset of the survey participants, the survey response including the identity of the at least one practitioner regarded by the participant as a key opinion leader in that therapy space;
a response management module operably connected to the database and the data server and being adapted to store a representation of each survey response in the database; and
a report generation module operably connected to the database and being adapted to generate at least one report for a pharmaceutical representative, after a predetermined number of responses are received, based in part on the stored representations of the survey responses, the at least one report including a list of medical practitioners identified in the survey responses who are relevant to adoption of the particular pharmaceutical.

7. The market intelligence portal according to claim 1, wherein the survey module comprises market intelligence data relevant to a medical company's treatment plan including names of practitioners and/or institutions relevant to promotion of a pharmaceutical product in a particular therapy space.

8. The market intelligence portal according to claim 1, wherein the survey module is further adapted to generate an opinion leader survey for the marketing campaign.

9. The market intelligence portal according to claim 8, wherein the survey includes a financial incentive to incentivise survey recipients to participate in the survey

10. The market intelligence portal according to claim 1, wherein the survey is further adapted to generate a list of survey participants based on a correlation between the recipients and a therapy space associated with the marketing campaign.

11. The market intelligence portal according to claim 10, wherein generating a list of survey participants comprises searching a database associated with the portal and generating surveys based on the results.

12. The market intelligence portal according to claim 10, wherein generating a list of survey participants comprises receiving a list and generating survey's based on the list.

13. The market intelligence portal according to claim 1, wherein the dashboard interface module comprises a practitioner profile module.

14. The market intelligence portal according to claim 13, wherein the practitioner profile module is adapted to create a practitioner profile from information stored in the survey module.

15. The market intelligence platform according to claim 14, wherein the practitioner profile module is further adapted to identify missing information from the practitioner profile and to obtain additional profile information from an external data source.

16. The market intelligence portal according to claim 15, wherein the additional profile information comprises one or more practitioner fields selected from the group consisting of scientific contributions, speaking experience, regulatory experience, institutional affiliation, educational background, awards, and clinical trial participation.

17. The market intelligence portal according to claim 13, wherein the data stream module periodically provides automatic updates to practitioner profile information in the practitioner profile module.

18. The market intelligence portal according to claim 13, wherein the dashboard interface module comprises a mapping module adapted to generate one or more dynamic social network diagrams for each practitioner having a profile.

19. The market intelligence portal according to claim 18, wherein a social network diagram illustrates a practitioner's connection to one or more other profiled practitioners based commonality in one or more of the practitioner fields.

20. The market intelligence portal according to claim 1, wherein the dashboard interface module comprises a clinical trials module.

21. The market intelligence portal according to claim 13, wherein the clinical trials module comprises a link to a clinical trials database.

22. The market intelligence portal according to claim 21, wherein clinical trial information accessible in the clinical trials module is associated with one or more opinion leading practitioners identified in the survey module.

23. The market intelligence portal according to claim 1, wherein the dashboard interface module comprises a visualization module adapted to provide dynamic user defined visualizations of data from the surveying module, data stream module, and influence mapping.

24. The market intelligence portal according to claim 1, wherein the campaign dashboard interface module comprises a watch list module.

25. The market intelligence portal according to claim 24, wherein the watch list module is adapted to permit a campaign dashboard viewer to designate one or more areas of interest.

26. The market intelligence portal according to claim 25, wherein an area of interest comprises at least one item selected from the group consisting of a single practitioner, multiple practitioners, a social network, an institution, a therapy space and combinations thereof.

27. The market intelligence portal according to claim 24, wherein the watch list module comprises alert module is adapted to generate an alert when an item on the watch list is updated with new information.

28. The market intelligence portal according to claim 27, wherein generating an alert comprises performing at least one action selected from the group consisting of sending an email message, inserting a visible alert on a dashboard view of the campaign dashboard module, sending a text message, and combinations thereof.

29. The market intelligence portal according to claim 1, wherein the data stream module comprises a connection to one or more self-updating remote data sources.

30. The market intelligence portal according to claim 20, wherein the self-updating remote data sources comprise sources selected from the group consisting of an Internet-based search engines, commercial data services, newswires, publications, prescriber databases, clinical trials databases, and combinations thereof.

31. The market intelligence portal according to claim 1, further comprising a subject matter expert review (SME) module.

32. The market intelligence portal according to claim 31, wherein the SME module comprises an interface for an expert to enter opinion leader survey response data into the survey module.

33. A market intelligence portal (MIP) system for providing a medical company with market intelligence data relevant to the medical company's marketing campaign comprising:
a network-based computer system comprising:
a surveying module, adapted to generate an opinion leader survey of practitioners working in a particular clinical therapy space relevant to the marketing campaign to identify practitioners regarded by the participants as key opinion leaders in the therapy space and to store the survey results;
a practitioner profile module adapted to create a practitioner profile for each opinion leader in the survey including one or more information fields selected from the group consisting of scientific contributions, speaking experience, regulatory experience, institutional affiliation, educational background, awards, and clinical trial participation;
a data stream module adapted to receive automatic data updates relevant to practitioner profiles;
an influence mapping module adapted to create at least one social network diagram for each identified practitioner, the social network diagram illustrating a connection between practitioners based on a commonality in one or more of the information fields;
a campaign dashboard module for accessing the practitioners profiles, social network diagrams and data updates over a computer network; and
an alert module adapted to permit viewers to establish an automatic alert when a practitioner profile is updated with data update information.

34. A method of obtaining market intelligence data related to marketing of a new pharmaceutical in a specific therapy space comprising:
identifying a number of practitioners working in the particular therapy space;
generating an opinion leader survey for the practitioners that requests the respondent to name at least one practitioner in the therapy space that the respondent regards as an opinion leader;
providing the opinion leader survey to the identified practitioners, including a financial incentive to participate in the survey;
receiving the survey responses and transcribing the response data into an electronic database;
for each identified opinion leader, obtaining additional information comprising one or more fields of information selected from the group consisting of scientific contributions, speaking experience, regulatory experience, institutional affiliation, educational background, awards, and clinical trial participation;
creating a practitioner profile for each named practitioner using the survey responses and the additional information;
creating a social network diagram for each named practitioner relative to other named practitioners based on commonality between one or more fields of the additional information;
creating a campaign dashboard for a requestor of the market intelligence data to interact with the practitioner profiles and social network diagrams; and
automatically updating the practitioner profile with information from one or more self-updating external data sources.
